(19) United States
(12) Patent Application Publication
(10) Pub. No.: US 2010/0098858 A1
(43) Pub. Date: Apr. 22, 2010

(54) Fluid Dispense System Coating

(75) Inventor: Van Nguyen Truskett, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/576,599

(22) Filed: Oct. 9, 2009

Related U.S. Application Data
(60) Provisional application No. 61/106,183, filed on Oct. 17, 2008.

(51) Int. Cl. B05D 5/00

(52) U.S. Cl. 427/256

(57) ABSTRACT

A fluid dispense system having a coating layer applied to the fluid flow path and the external surfaces is described. The coating layer is chemically resistant to the working fluids of the fluid dispense system and prevents the leaching of a plurality of ions from the fluid dispense system.

### CROSS-REFERENCE TO RELATED APPLICATIONS

This application claims the benefit under 35 U.S.C. §119(e)(1) of U.S. Provisional Patent Application No. 61/106,183, filed Oct. 17, 2008, which is hereby incorporated by reference herein in its entirety.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a polymerizable layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of one embodiment of a lithographic system in accordance with the present invention.

FIG. 2 illustrates a simplified side view of the substrate shown in FIG. 1 having a patterned layer positioned thereon.

FIG. 3 illustrates a simplified side view of an exemplary fluid dispense system.

FIG. 4 illustrates a simplified side view of an exemplary fluid dispense system having a coating layer.

FIG. 5 illustrates examples of compounds for use within coating layer.

FIG. 6 illustrates a flow chart of an exemplary method for passivating fluid dispense system with coating layer.

### DETAILED DESCRIPTION

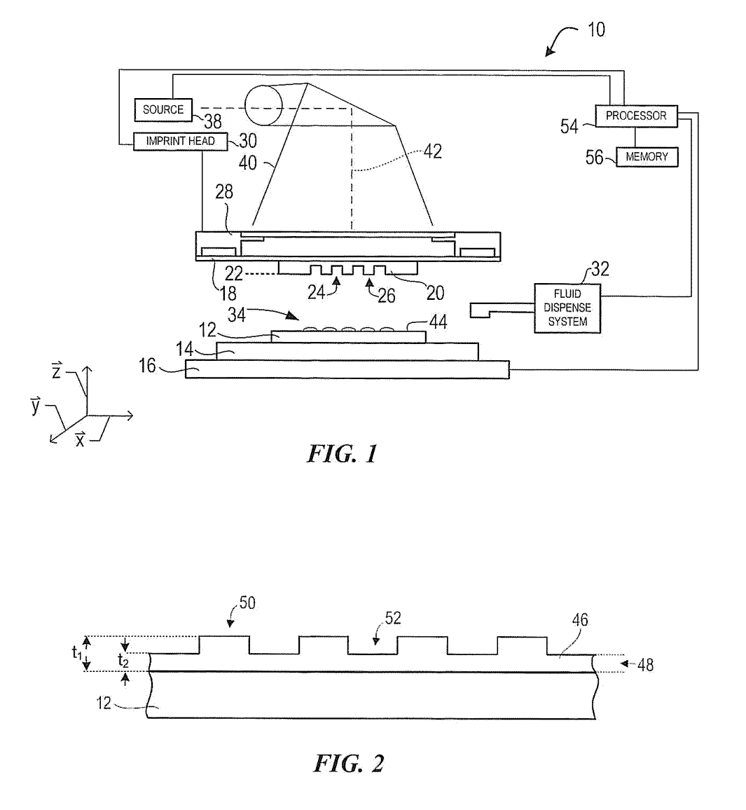

Referring to the figures, and particularly to FIG. 1, illustrated therein is a lithographic system 10 used to form a relief pattern on a substrate 12. Substrate 12 may be coupled to a substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference.

Substrate 12 and substrate chuck 14 may be further supported by a stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a mesa 20 extending therefrom towards substrate 12, mesa 20 having a patterning surface 22 thereon. Further, mesa 20 may be referred to as a mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to a chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 28 may be coupled to an imprint head 30 such that chuck 28 and/or imprint head 30 may be configured to facilitate movement of template 18.

System 10 may further comprise a fluid dispense system 32. Fluid dispense system 32 may be used to position a polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 22 and substrate 12 depending on design considerations. Polymerizable material 34 may comprise a monomer as described in U.S. Pat. No. 7,157,036 and U.S. Patent Publication No. 2005/0187339, all of which are hereby incorporated by reference. An exemplary composition of polymerizable coating 34, as incorporated by reference from U.S. Pat. No. 7,157,036, may include isobornyl acrylate comprising approximately 55% of the composition, n-hexyl acrylate comprising approximately 27%, ethylene glycol diacrylate approximately comprising 15% of the composition, and the initiator 2-hydroxy-2-methyl1-phenyl-propan-1-one comprising approximately 3% of the composition. The initiator is sold under the trade name DAROCUR 1173 by CIBA of Tarrytown, N.Y. Also, less than 1% of the composition may include a surfactant with the general structure of R,R₂ where R₁═F(CF₂CF₂)_{y}, with y being in the range of 1 to 7, and R₂═CH₂CH₂O(CH₂CH₂O)ₓ, inclusive where X is in the range of 0 to 15 inclusive. The composition above also includes stabilizers that are well known in the chemical art to increase the operational life of the composition. In one alternative embodiment, the composition above may not include the surfactant. A second exemplary composition, as incorporated by reference from U.S. Pat. Pub. 2005/0187339, has a viscosity associated therewith and including a surfactant, a polymerizable component, and an initiator responsive to a stimuli to vary the viscosity in response thereto, with the composition, in a liquid state, having the viscosity being lower than 100 centipoises, a vapor pressure of less than 20 Torr, and in a solid cured state a tensile modulus of greater than 100 MPa, a break stress of greater than 3 MPa, and an elongation at break of greater than 2%.

Referring to FIGS. 1 and 2, system 10 may further comprise an energy source 38 coupled to direct an energy 40 along a path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in a memory 56.

Either imprint head 30, stage 16, or both vary a distance between mold 20 and substrate 12 to define a desired volume there between that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46, as shown in FIG. 2, on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference.

As described above, polymerizable material 34 may be applied to the defined volume between template 18 and substrate 12 using a fluid dispense system 32. Exemplary fluid dispense systems 32 may include, but are not limited to a printhead, a microjet tube, syringe, or similar systems that are able to eject a drop of fluid. For example, systems that are able to eject a drop of fluid ≦50 picoliters.

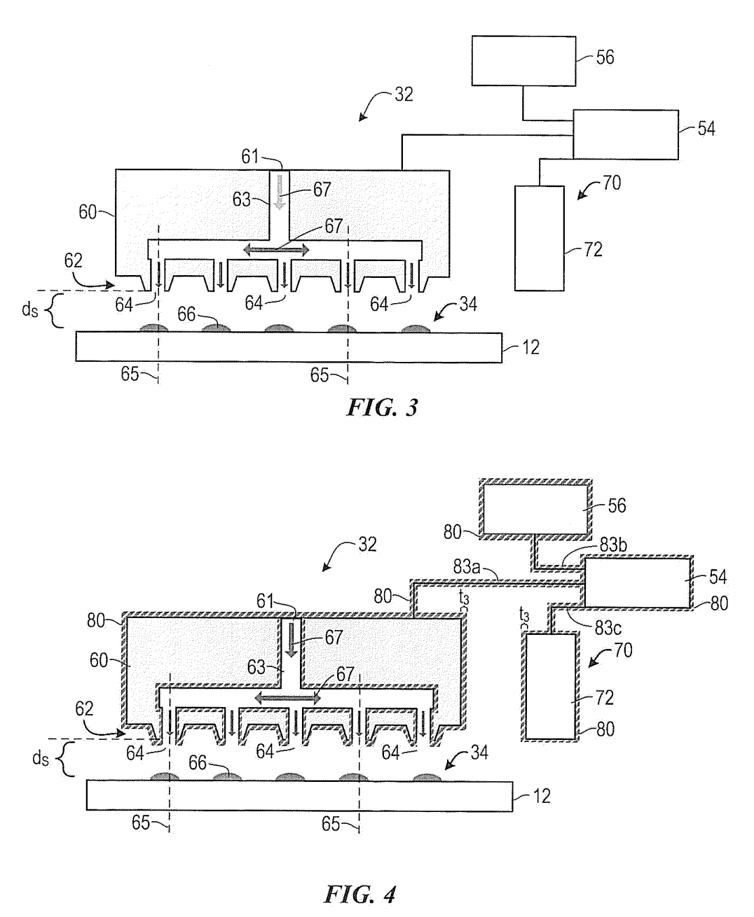

FIG. 3 illustrates an exemplary embodiment of fluid dispense system 32. Fluid dispense system 32 may comprise a dispense head 60 and nozzle system 62. Nozzle system 62 may comprise a single tip 64 or a plurality of tips 64 depending on design considerations. For example, FIG. 3 illustrates nozzle system 62 comprising a plurality of tips 64. Generally, polymerizable material 34 enters inlet valve 61, propagates through channel 63 along flow path 67, and egresses from tip 64 of nozzle system 62. Tip 64 defines a dispensing axis 65 at which polymerizable material 34 may be positioned on substrate 12. The distance dₛ between tip 64 and substrate 12 may be selected so as to minimize, or prevent splashing; minimize, or prevent gas from being present, and/or other similar design considerations.

Polymerizable material 34 may be positioned by fluid dispense system 32 on substrate 12 as a droplet 66. Exemplary droplet techniques for positioning polymerizable material 34 on substrate 12 are described in detail in

U.S. Patent Publication No. 2005/0270312 and U.S. Patent Publication No. 2005/0106321, all of which are hereby incorporated by reference.

Fluid dispense system 32 may also comprise a vision system 70. Vision system may include a microscope 72 (e.g. optical microscope) to provide microscopic and/or macroscopic views of droplets 66 on substrate 12. Dispense head 60 and/or microscope 72 may be regulated by processor 54, and further may operate on a computer readable program stored in memory 56.

Fluid dispense system 32 may be formed of materials that leach ions into the polymerizable material 34. Leaching may substantially alter the purity level of the polymerizable material 34 and may contaminate the imprint process as imprint process materials may be manufactured to have low ion content (e.g., ≦25 ppb electronic grade or ppb semiconductor grade for the following ions: Al, Ca, Cr, Cu, Fe, Li, Mg, Mn, Ni, K, Na, Sn, and Pb).

Although use of the fluid dispense system 32 as it applies to the imprint process is discussed in detail herein, it should be noted that the fluid dispense system 32 may be used in other applications. For example, in bio related applications, bio-functional compounds that flow through fluid dispense system 32 may absorb leached containments from fluid dispense system 32. Additionally, bio-functional compounds may adsorb on wetted surfaces of the fluid dispense system 32 and may potentially reduce concentration of the active contents of the fluid. As such, dispensing of bio-functional compounds may yield inadequate characteristics for sensing and/or detecting applications.

Liquids flowing through the fluid dispense system 32 may be corrosive, clog and/or impede fluid flow. For simplicity of description, polymerizable material 34 is discussed hereinafter, however, any liquid may flow through fluid dispense system 32.

Passivating fluid dispense system 32 may protect polymerizable material 34 from contaminants of materials used to form fluid dispense system 32. Additionally, passivating fluid dispense system 32 may protect fluid dispense system 32 from clogging. Generally, a coating layer 80 may be distributed over internal and external surfaces of fluid dispense system 32 and its associated fluid delivery components, such as tubing, fittings, valves, and liquid reservoir(s). For example, as illustrated in FIG. 4, coating layer 80 may be distributed on the walls of channel 63 within the flow path 67 of the fluid dispense system 32. Additionally, coating layer 80 may be distributed over exterior portions of fluid dispense system 32. For example, coating layer 80 may be distributed over the external portions of tips 64, external portions of dispense head 60, microscope 70, processor 54, and the like. Additionally, coating layer 80 may be distributed over communication links 83a-c, the communication links being wired or wireless.

In one example, coating layer 80 may be applied by chemical vapor deposition, however, it should be noted that other processes for applying coating layer 80 may be used. Coating layer 80 may have a thickness t₃. For example, thickness t₃ may be less than 100 microns, or as in one embodiment, equal to or less than 15 microns. The coating layer 80 may include substituted and unsubstituted poly(p-xylylenes), such as substituted and unsubstituted poly(p-xylxylene) and poly(halo-p-xylxylenes) (e.g., poly(chloro-p-xylylene), poly(fluro-p-xylylene, and poly(iodo-p-xylxylene)). Substituted poly(p-xylxylenes) may include, for example, sulfonated, aminomethylated, and amidomethylated poly(p-xylylene) and poly(halo-p-xylylenes), plasma treated forms of poly(p-xylylene) and poly(halo-p-xylxylenes) the wet chemical modifications of poly(p-xylylene), poly(chloro-p-xylylene), and poly(fluro-p-xylylene) by sulfonation, aminomethylation, or amdiomethylation, and/or the like.

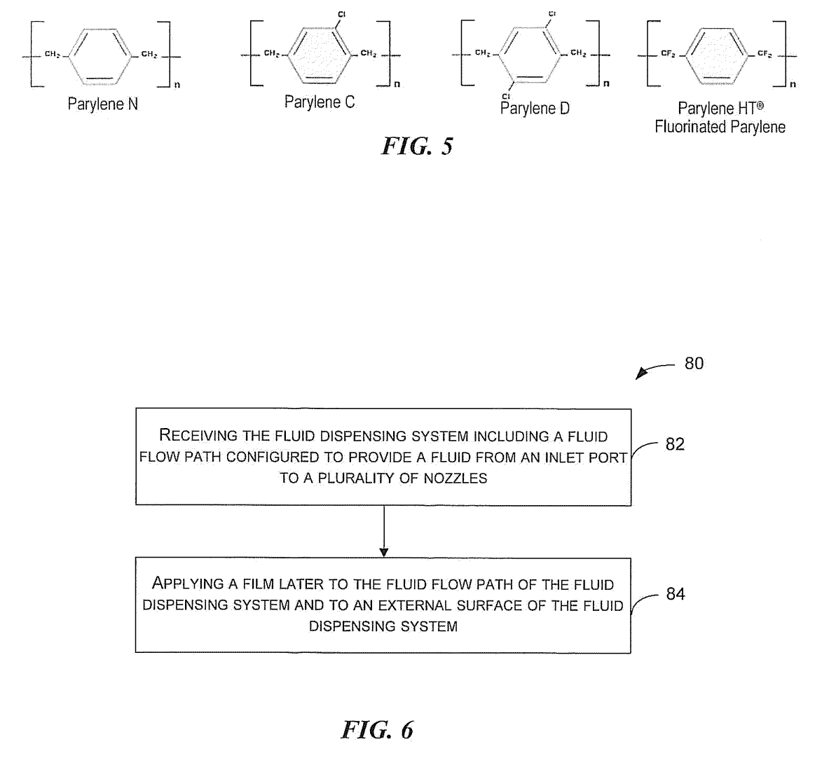

Poly(p-xylylene) is also known by its trade name Parylene which is manufactured by Specialty Coating Systems of Indianapolis, Ind. Poly(chloro-p-xylylene) is also known by its trade name Parylene C or Parylene D which are manufactured by Specialty Coating Systems of Indianapolis, Indiana. One fluorine derivative of poly(p-xylylene) is also known by its trademark name Parylene HT® which is manufactured by Specialty Coating Systems of Indianapolis, Ind. Exemplary materials for coating layer 80 are illustrated in FIG. 5.

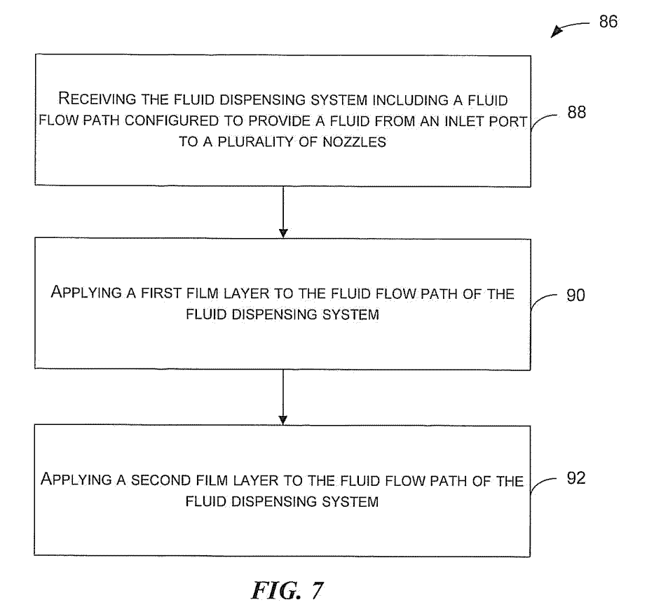

FIG. 6 illustrates an exemplary embodiment of a method for passivating fluid dispense system 32 with coating layer 80. In a step 82, receiving fluid dispense system 32 that includes a fluid flow path 67 configured to provide a fluid from inlet port 61 to a plurality of nozzles 62. In a step 84, coating layer 80 may be applied to fluid flow path 67 and external surfaces of fluid dispense system 32.

FIG. 7 illustrates an exemplary embodiment of a method 86 for passivating fluid dispense system 32 with coating layer 80. In a step 88, receiving fluid dispense system 32 that includes a fluid flow path 67 configured to provide a fluid from inlet port 61 to a plurality of nozzles 62. In a step 90, a first film layer 80 may be applied to fluid flow path 67. In a step 92, a second film layer 80 may be applied to the external surfaces of fluid dispense system 32.

1. A method for coating a nano-imprint lithography fluid dispense system, the method comprising:
applying a first coating composition to the fluid flow path of the nano-imprint lithography fluid dispense system, wherein the fluid flow path couples an inlet port with a plurality of nozzles and wherein the coating forms a layer on a surface of the fluid flow path; and
applying a second coating composition to an external surface of the nano-imprint lithography fluid dispense system, wherein the second coating forms a layer on the external surface of the nano-imprint lithography fluid dispense system,

2. The method of claim 1, wherein the first coating composition and the second coating composition comprise a poly(p-xylylene),

3. The method of claim 2, wherein the poly(p-xylylene) is a poly(halo-p-xylxylene).

4. The method of claim 3, wherein the poly(halo-p-xylylene) is selected from the group consisting of poly(chloro-p-xylylene), poly(fluoro-p-xylylene) and poly(iodo-p-xylxylene).

5. The method of claim 4, wherein the poly(p-xylylene) is substituted.

6. The method of claim 5, wherein the substituted poly(p-xylxylene) is selected from the group consisting of sulfonated poly(p-xylxylenes), aminomethylated poly(p-xylylenes), and amidomethylated poly(p-xylylenes).

7. The method of claim 1, further comprising plasma treating at least one of the layers.

8. The method of claim 1, wherein a thickness of the layer on the surface is less than about 15 micrometers.

9. The method of claim 1, wherein at least one of the nozzles is configured to eject a drop of fluid having a volume of less than or equal to about 50 picoliters.

10. The method of claim 1, further comprising dispensing a fluid composition from the fluid dispense system, wherein the composition comprises a surfactant, a polymerizable component, and an initiator responsive to a stimulus to vary a viscosity of the composition in response thereto, wherein the fluid composition has a viscosity less than about 100 centipoise in a temperature range between about 20° C. and about 25° C., and a vapor pressure of less than about 20 Torr, and wherein the composition, in a solid cured state, has a tensile modulus of greater than about 100 MPa, a break stress of greater than about 3 MPa and an elongation at break of greater than about 2%.

11. The method of claim 1, wherein the fluid dispense system comprises a fluid reservoir and a fluid distribution manifold comprising tubing, valves, and fittings.

12. The method of claim 1, wherein each layer is chemically resistant to the fluid in the fluid dispense system.

13. The method of claim 1, wherein each layer is operable to inhibit leaching of ions from the fluid dispense system.

14. The method of claim 13, wherein the ions are selected from the group consisting of aluminum, calcium, chromium, copper, iron, lithium, magnesium, manganese, nickel, potassium, sodium, tin, and lead.

15. A method for coating a fluid dispensing system, comprising:
receiving the fluid dispensing system including a fluid flow path configured to provide a fluid from an inlet port to a plurality of nozzles;
applying a first film layer to the fluid flow path of the fluid dispensing system; and
applying a second film layer to an external surface of the fluid dispensing system.

16. The method of claim 15, wherein the first film layer and the second film layer comprise a poly(p-xylylene).

17. The method of claim 16, wherein the poly(p-xylylene) is a poly(halo-p-xylxylene).

18. The method of claim 17, wherein the poly(halo-p-xylylene) is selected from the group consisting of poly(chloro-p-xylylene), poly(fluoro-p-xylylene), and poly(iodo-p-xylxylene).

19. The method of claim 4, wherein the poly(p-xylylene) is substituted.

20. A method for coating a fluid dispensing system, comprising:
receiving the fluid dispensing system including a fluid flow path configured to provide a fluid from an inlet port to a plurality of nozzles;
applying a film layer to the fluid flow path of the fluid dispensing system and to an external surface of the fluid dispensing system; and
wherein the film layer is configured to be chemically resistant to the fluid and to prevent leaching of a plurality of ions from the fluid dispensing system.
